(19) United States
(12) Patent Application Publication
(10) Pub. No.: US 2006/0288338 A1
(43) Pub. Date: Dec. 21, 2006

(54) Offset threaded code

(76) Inventors: Jinzhan Peng, Beijing (CN); Ken Lueh, Santa Clara, CA (US); Gansha Wu, Beijing (CN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/154,077

(22) Filed: Jun. 15, 2005

(51) Int. Cl. G06F 9/45

(52) U.S. Cl. 717/151

(57) ABSTRACT

Translating a virtual machine instruction into a value which when logically combined with a base value yields an address of interpretation code to perform the virtual machine instruction.

### BACKGROUND

Processor based systems such as personal computers, including desktop and laptop computers, servers, handheld computers such as portable digital assistants (PDAs) and many others, including game consoles, set-top boxes, and mobile phones, execute programs that provide aspects of their functionality. High level source code language that may be used to write such programs is generally translated into simpler or lower level forms, and ultimately into an executable form before the program may be executed by a processor based system. In executable form, a program is made up of object code executable by an Intel® processor or another processor.

Translators that convert high level source programs to executable programs may be generally divided into compilers and interpreters. While compilers are used to translate source code into an executable file which may later be executed by a processor based system, interpreters perform translation “on-the-fly” and directly execute executable code corresponding to source code instructions.

An intermediate approach is used in programming language systems such as Java and Forth that have both a compilation phase and an interpretation phase. In these types of systems, an initial phase converts source code into a platform independent format called intermediate code or bytecode. At execution time, a bytecode interpreter then interprets the bytecode to execute the program on a particular processor based system. Generally bytecode may be a more compact representation of the program than the executable, but larger than the source code; and moreoever, a machine language code segment corresponding to an individual bytecode instruction is generally smaller than a machine language code segment corresponding to a construct of the high level source programming language. The bytecode may be thought of as an instruction set for a virtual machine, because the instructions used in bytecode are simpler than the full-fledged programming features available at a high level, e.g. in Java, but at a higher level than typical machine language instructions of a processor that form executable code. A bytecode or intermediate code interpreter may thus be termed a virtual machine, and bytecode may be termed virtual machine instruction code. Thus, in the case of Java, Java bytecode interpreters may be termed Java Virtual Machines. The terms intermediate code, bytecode, and virtual machine instruction code are used interchangeably herein.

Threaded interpreters are a well known type of interpreter for virtual machine instruction programs, described originally in James R. Bell, Threaded Code, Communications of the ACM, vol. 16, no. 6, pp 370-372, 1973, and further in M. Anton Ertl, A(Portable) Forth Engine, EuroFORTH '93 Conference Proceedings, 1993. During interpretation by a threaded interpreter, a bytecode or intermediate code program is translated into interpretation code that corresponds to each virtual machine instruction in the program or to each virtual machine instruction type; and a threaded code entry point array is created, with an entry corresponding to each instruction in the bytecode. During the execution phase, the interpreter uses the entry point array to efficiently transfer control to the code in the interpretation code corresponding to each bytecode instruction.

Threaded interpreters are especially attractive for devices with small memories such as handheld computers or mobile phones, which must store programs in onboard flash memory compactly, but may not have full fledged compilation systems for handling high level source programs. Often, bytecode or virtual machine instruction code programs are stored on such devices. Because of the limited memory and lower processing capability of such devices as compared to personal computers or servers, interpreters for such devices are constrained both in terms of memory utilization and execution efficiency.

It is worthwhile to note that threaded interpreters should not be confused with the term “thread,” sometimes used to describe one of a set of concurrently executing processes in a processor based system that supports concurrent execution.

### BRIEF DESCRIPTION OF THE DRAWINGS

FIG. 1a (Prior Art) depicts a direct threaded interpretation scheme.

FIG. 1b (Prior Art) depicts an indirect threaded interpretation scheme.

FIG. 2 is a block diagram of a virtual machine code interpreter in one embodiment.

FIG. 3 is a block diagram of a threaded code implementation in one embodiment.

FIG. 4 is a flow diagram of a bytecode translator in one embodiment.

FIG. 5 is a flow diagram of a virtual machine instruction dispatcher in one embodiment.

FIG. 6 depicts a processor based system in one embodiment.

### DETAILED DESCRIPTION

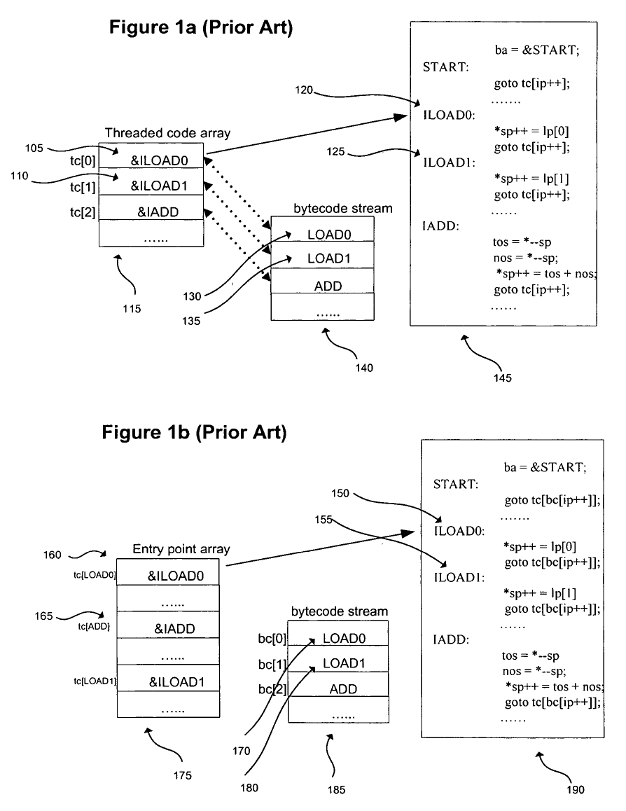

Threaded interpreters are known in the art. FIG. 1a and FIG. 1b depict two existing forms of threaded interpreters for virtual machine code. In FIG. 1a, a bytecode stream 140 is translated into a threaded code array 115 which is used to execute the interpretation code 145 that corresponds to the instructions such as 130, 135 etc. in the bytecode stream. For example, the instruction LOAD0 at 130 is eventually executed by the interpreter by transfer of control to the interpretation code at 120. In the depiction, the interpretation code is written in syntax similar to that of the C language for ease of exposition; however, the interpretation code would typically be executable object code for a processor. In FIG. 1a, the translation phase of the threaded interpreter loads into threaded code array 115 a sequence of jump addresses, each corresponding to the interpretation code for a bytecode instruction in the bytecode stream. For example, the threaded array position tc[0] at 105 is loaded with the jump address &ILOAD0 corresponding to the interpretation code labeled ILOAD0 at address &ILOAD0, 120, for the bytecode instruction LOAD0 at 130; the threaded array position tc[1] at 110 is loaded with the jump address corresponding &ILOAD1 to the interpretation code at lable ILOAD1, 125, for the bytecode instruction LOAD1 at 135. Thus, when the interpreter executes the bytecode, it effectively executes the following code, expressed in C-like syntax: goto tc[ip++]. Here, ip represents an instruction pointer that begins at 0.

As may be observed from FIG. 1 and the above description, control travels from the threaded code entry point array to the interpretation code and back to the threaded code entry point array, and the instruction pointer then moves down the threaded code entry point array in sequence. Thus, as many threaded code entries are required as there are instructions in the bytecode stream. This is the simplest threaded code interpretation scheme and is termed direct threaded code. The execution of this type of interpreter is very fast, however, the need to have a threaded code array with a number of entries approximately equal to the number of bytecode instructions, coupled with the size of the addresses that must be stored in each position in the threaded code array, may result in a large threaded code array. In some instances, each threaded code entry is four bytes in size, while each bytecode instruction is one byte long, and so a threaded code array about four times the size of the bytecode stream is required to implement direct threading.

FIG. 1b depicts a modification of the scheme described above with reference to FIG. 1a. In FIG. 1b, each bytecode instruction in bytecode stream 185 is used during interpretation to index into an entry point array 175. At the location corresponding to an index with the value of the bytecode instruction is the address of the interpretation code 190 for the bytecode instruction. Thus, the interpretation code 150 for the first instruction in the bytecode 185, the instruction ILOAD0 at 170 is found a location which is stored in the threaded code array tc at tc[LOAD0] at 160. In this case, an instruction pointer ip refers to the bytecode stream instead of to the threaded code array. After execution of the interpretation code for an instruction, the instruction pointer is advanced and the next bytecode instruction is used as an index to another location in the threaded code array. Thus, when the interpreter executes the bytecode, it effectively executes the following code, expressed in C-like syntax: goto tc[bc[ip++]]. Here, as before ip represents the instruction pointer and begins at 0.

This scheme called indirect threading generally requires less storage space for the entry point array than the direct threading scheme. This is because the number of entries in the entry point array is approximately equal to the number of different instruction types in the bytecode stream and is independent of the length of the bytecode stream. However, this efficiency is realized at the cost of an additional memory reference for each bytecode instruction executed that is unnecessary in the direct threaded scheme. This is because the interpreter must first retrieve the bytecode value at the index referenced by ip and then retrieve the jump address from the entry point array referenced by the bytecode value. This can cause a significant slowdown of the execution of a program.

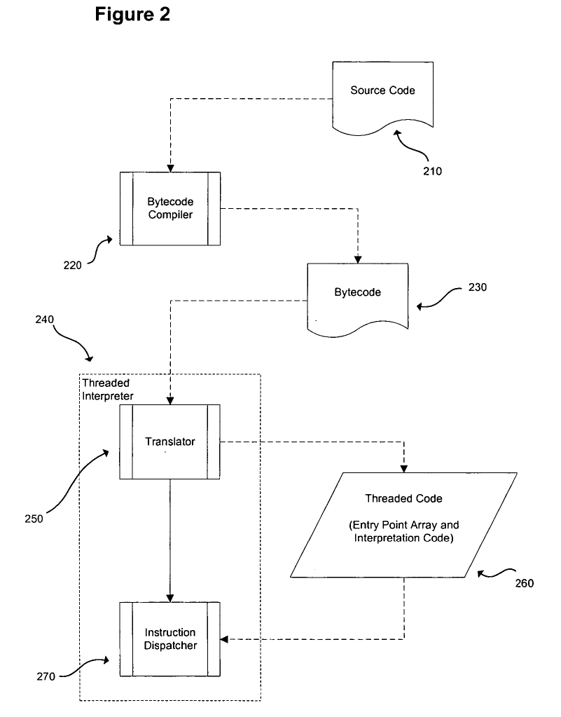

In one embodiment depicted in FIG. 2, source code such as Java or Forth code 210 is translated into an intermediate form or bytecode 230 by a compiler 220. The bytecode is interpreted by a threaded interpreter 240 in one embodiment that comprises a translator 250 and an execution component or instruction dispatcher 270. The translator converts the bytecode 230 into an entry point array and interpretation code that comprise the threaded code 260. The instruction dispatcher uses the entry point array to execute instructions in the bytecode by executing the corresponding code segments in the entry point array based on addresses within the interpretation code computed with reference to the entry point array.

The actual organization of the scheme depicted in FIG. 2 may vary among embodiments. In some embodiments an interpreter program or system may be provided as a set of modules that differ from the ones depicted in FIG. 2. As mentioned earlier, the source code may be in one of a large variety of high level programming languages as is known in the art, such as Pascal, Forth, Java and BASIC, among many others amenable to interpretation. In some embodiments terms such as intermediate code, p-code, or virtual machine instruction code may be used to refer to bytecode 230; in others the threaded interpreter 240 may be called a virtual machine, or by other similar names. Also, structures equivalent to an array such as a list or other data structure may be used to store entry points in the threaded code. Many other variations are possible.

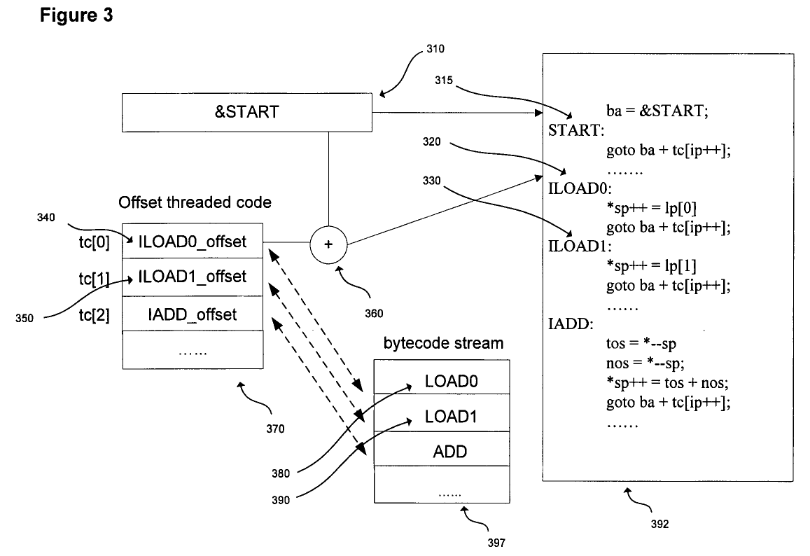

The translator and instruction dispatcher depicted in the embodiment of FIG. 2 use a scheme to store threaded entry points and instruction dispatching that differs from both indirect and direct threading. This scheme, termed offset threaded code, is shown in the embodiment depicted in FIG. 3. In FIG. 3, bytecode stream 397 is translated into a threaded code array 370 which is used to execute the interpretation code 380 that corresponds to the instructions in the bytecode. In offset threaded code, just as in direct threaded code, there is generally a one-one correspondence between the bytecode stream and the offset threaded code array. Unlike the direct threaded code, however the offset threaded code array does not store the address of the interpretation code segment corresponding to a bytecode instruction, but rather an offset to the interpretation code from a base address. In one example, the instruction LOAD0 at 380 in the bytecode is eventually executed by the interpreter by transfer of control to the interpretation code at 320. In FIG. 3, the translation phase of the threaded interpreter loads into the threaded code offset threaded code array 370 a sequence of jump address offsets. Each offset is an offset from a base address &START referencing the start address of the interpretation code labeled START, at 315 and stored in a global register 310. The address obtained by adding the entry in the offset threaded code array to the base address yields the address of the interpretation code for a bytecode instruction in the bytecode stream to which the entry point corresponds. For example, the threaded array position tc[0] at 340 is loaded with the jump address offset ILOAD0_offset corresponding to the interpretation code 320 for the bytecode instruction LOAD0 at 380; the threaded array position tc[l] at 350 is loaded with the jump address offset corresponding to the interpretation code 330 for the bytecode instruction ILOAD1 at 390. Thus, when the interpreter executes the bytecode, it effectively executes the following code, expressed in C-like syntax: goto ba+tc[ip++]. Here, ba represents the base address in the global base address register, and ip represents an instruction pointer that begins at 0. Thus for example the interpreter, to execute the bytecode instruction LOAD1 at 390, adds the base register contents &START and the contents of tc[l], ILOAD1_offset, at 350, to yield &ILOAD1, the address of label ILOAD 1 at 330.

Just as in the direct threaded scheme, as many threaded code entries are required as there are instructions in the bytecode stream; however, because the size of the offset that must be stored in each position in the threaded code array is smaller than the stored address in the direct threaded scheme, the offset threaded code array in general will be significantly smaller than the entry point array in the direct threaded scheme. However, just as in the direct threaded scheme, only one memory reference is made to the array tc; one extra addition is necessary, though generally takes significantly less time than a memory reference.

It is possible to generalize the scheme of FIG. 3 as follows. If for any bytecode instruction, the offset of the interpretation code from a base address is d, then it is necessary to compute d from the value o stored in the offset threaded code. In the example above, the value of o is chosen to be d itself. That is, the transformation from the actual offset value to offset threaded code T(d) is T(d)=d, and thus the inverse of T used to obtain the offset from the stored value is T¹(o)=o. In general, however, any function T that allows for memory efficiency in the storage of o and computational efficiency in terms of computing T¹, the inverse of T, that is used to obtain d from o, may be used.

For example, the scheme described with reference to FIG. 3 may be improved in one embodiment, if each offset value is 2ⁿ byte-aligned. In this case, the last n bits of each value of d will be zeroes and therefore d may be right shifted n bits before storage in the offset threaded code array, producing a saving of n bits for each bytecode instruction. That is, in this embodiment, T(d)=d>>n; and T¹(o)=o<<n. Thus, in this instance, the C-like function used by the interpreter to execute bytecode would then be goto ba+(tc[ip++]>>n).

Many variations on the above schemes are possible. The actual value of the base register may be different from the start address of the interpretation code by a fixed constant. While the FIG. 3 depicts an array like structure for the storage of threaded code offset, in some embodiments, other equivalent data structures may be used such as linear lists implemented as linked lists, among others known in the art. As previously indicated, the bytecode instructions LOAD0, LOAD1, and ADD and the interpretation code depicted in C-like syntax in FIG. 3 are merely exemplary. Any form of virtual machine instruction code, bytecode, or intermediate code may be used to implement the scheme described above. The actual interpretation code, depicted for expositionary ease in C-like syntax, in actuality is object code for a particular platform or processor based system. This object code may vary depending on the specific bytecode language and the underlying platform on which the interpreter is to execute, and may thus be in object code of a different type in some embodiments. The addition of offsets to a base address may or may not be done by an explicit add instruction. In some instruction sets, the addition may be incorporated directly into an addressing instruction. In others, an equivalent logical operation may be used. Many variations are possible. Finally, compression schemes other than bit-shifting as described above may be used to store offsets. Many such schemes are known in the art.

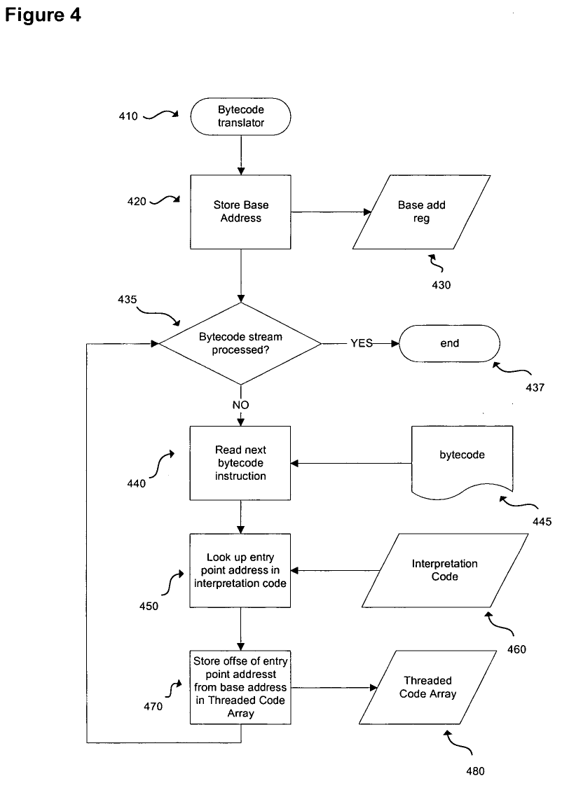

FIG. 4 depicts a bytecode translation component of a threaded code interpreter in one embodiment. On invocation 410, the translator first stores a base address at 420 based on which all offsets are calculated. As long as more bytecode instructions remain, 435 (NO exit), the interpreter reads, 440 the next virtual machine, or bytecode, instruction in the bytecode stream, 445. It then looks up the entry point address for the virtual machine instruction, 450 in the interpretation code 460. It then stores the offset of the entry point address from the base address in the threaded code array, 480. The process continues until all bytecode processing is complete, 435 (YES exit) at which point the translation phase completes, 437.

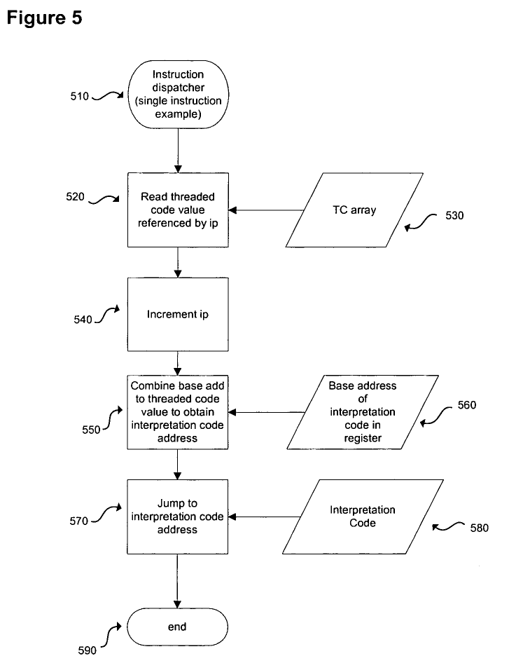

FIG. 5 depicts the processing of the instruction dispatch portion of the threaded interpreter in one embodiment. This processing begins at 510, for the dispatch of any instruction. The threaded code value at the instruction pointer ip, is read from the threaded code array 530. The instruction pointer is incremented to prepare for the next dispatch, 540. At 550, the base address 560 is combined with the value read from the array, for example, by adding it to the base address. This yields an interpretation code. Execution is then transferred by an instruction like a jump, 570, to the appropriate point in interpretation code 580.

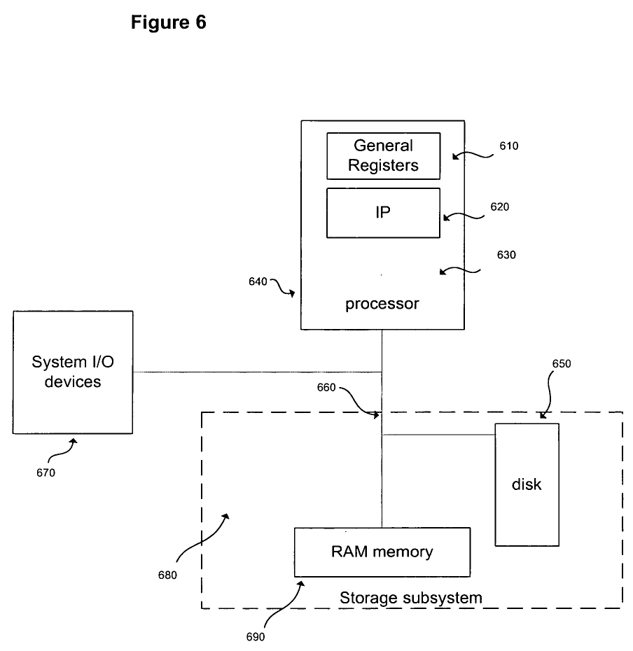

An embodiment of a processor based system that may be used to implement a threaded interpreter is depicted in FIG. 6. Such a system includes a processor 640, a storage subsystem including a read-write random access memory (RAM memory) 690 to store data and programs executable by the processor, and a non-volatile storage unit such as a disk system 650, interconnected by a bus system 660, and interfacing with the external network or users through system input/output (I/O) devices and peripherals 670. The processor may include a set of general registers 610 for processes executing on the processor to store frequently used data including an instruction pointer (IP) 620. As is known, many other components such as a cache, logic units, pipelines, etc. are also present as components of a processor and similarly other components may be present in a processor-based system, but are not depicted here in the interest of clarity.

In the preceding description, for purposes of explanation, numerous specific details are set forth in order to provide a thorough understanding of the described embodiments, however, one skilled in the art will appreciate that many other embodiments may be practiced without these specific details.

Some portions of the detailed description above are presented in terms of algorithms and symbolic representations of operations on data bits within a processor-based system. These algorithmic descriptions and representations are the means used by those skilled in the art to most effectively convey the substance of their work to others in the art. The operations are those requiring physical manipulations of physical quantities. These quantities may take the form of electrical, magnetic, optical or other physical signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the description, terms such as “executing” or “processing” or “computing” or “calculating” or “determining” or the like, may refer to the action and processes of a processor-based system, or similar electronic computing device, that manipulates and transforms data represented as physical quantities within the processor-based system's storage into other data similarly represented or other such information storage, transmission or display devices.

In the description of the embodiments, reference may be made to accompanying drawings. In the drawings, like numerals describe substantially similar components throughout the several views. Other embodiments may be utilized and structural, logical, and electrical changes may be made. Moreover, it is to be understood that the various embodiments, although different, are not necessarily mutually exclusive. For example, a particular feature, structure, or characteristic described in one embodiment may be included within other embodiments.

Further, a design of an embodiment that is implemented in a processor may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, data representing a hardware model may be the data specifying the presence or absence of various features on different mask layers for masks used to produce the integrated circuit. In any representation of the design, the data may be stored in any form of a machine-readable medium. An optical or electrical wave modulated or otherwise generated to transmit such information, a memory, or a magnetic or optical storage such as a disc may be the machine readable medium. Any of these mediums may “carry” or “indicate” the design or software information. When an electrical carrier wave indicating or carrying the code or design is transmitted, to the extent that copying, buffering, or re-transmission of the electrical signal is performed, a new copy is made. Thus, a communication provider or a network provider may make copies of an article (a carrier wave) that constitute or represent an embodiment.

Embodiments may be provided as a program product that may include a machine-readable medium having stored thereon data which when accessed by a machine may cause the machine to perform a process according to the claimed subject matter. The machine-readable medium may include, but is not limited to, floppy diskettes, optical disks, DVD-ROM disks, DVD-RAM disks, DVD-RW disks, DVD+RW disks, CD-R disks, CD-RW disks, CD-ROM disks, and magneto-optical disks, ROMs, RAMs, EPROMs, EEPROMs, magnet or optical cards, flash memory, or other type of media/machine-readable medium suitable for storing electronic instructions. Moreover, embodiments may also be downloaded as a program product, wherein the program may be transferred from a remote data source to a requesting device by way of data signals embodied in a carrier wave or other propagation medium via a communication link (e.g., a modem or network connection).

Many of the methods are described in their most basic form but steps can be added to or deleted from any of the methods and information can be added or subtracted from any of the described messages without departing from the basic scope of the claimed subject matter. It will be apparent to those skilled in the art that many further modifications and adaptations can be made. The particular embodiments are not provided to limit the claimed subject matter but to illustrate it. The scope of the claimed subject matter is not to be determined by the specific examples provided above but only by the claims below.

What is claimed is:

1. A method comprising translating a virtual machine program into a threaded code program by translating a virtual machine instruction of the program into an offset value which when logically combined with a base value yields the address of interpretation code to perform the virtual machine instruction.

2. The method of claim 1 wherein the value further comprises an offset value which when added to the base value yields the address of the interpretation code.

3. The method of claim 1 wherein the value further comprises an offset value which when shifted and added to the base value yields the address of the interpretation code.

4. The method of claim 1 wherein the virtual machine instruction is an instruction in a program comprising a translation of a high level source program.

5. The method of claim 1 further comprising translating substantially all virtual machine instructions of the program into an offset value which when logically combined with a base value yields the address of interpretation code to perform the virtual machine instruction.

6. The method of claim 5 wherein the virtual machine program comprises a translation of a high level source program into a virtual machine instruction set.

7. The method of claim 6 where the virtual machine program is a bytecode program for a Java virtual machine and the high level source program is a Java program.

8. A method of executing a program comprising: adding an element of a threaded code program to a base value to yield an address and executing a code at the address.

9. The method of claim 8 wherein the threaded code program comprises a translated virtual machine program.

10. The method of claim 9 wherein the virtual machine program is a bytecode program for a Java virtual machine.

11. A system comprising:
a processor;
a storage to store programs executable on the processor;
and a program stored in the storage to translate a virtual machine program into a threaded code program by translating a virtual machine instruction of the program into an offset value which when logically combined with a base value yields the address of interpretation code to perform the virtual machine instruction.

12. The system of claim 11 wherein the value further comprises an offset value which when added to the base value yields the address of the interpretation code.

13. The system of claim 11 wherein the value further comprises an offset value which when shifted and added to the base value yields the address of the interpretation code.

14. The system of claim 11 wherein the virtual machine instruction is an instruction in a program comprising a translation of a high level source program.

15. A system comprising:
a processor;
a storage to store programs executable by the processor; and
an interpreter stored in the storage to execute a program comprising: adding an element of a threaded code program to a base value to yield an address and executing a code at the address.

16. The system of claim 15 wherein the threaded code program comprises a translated virtual machine program.

17. The system of claim 16 wherein the virtual machine program is a bytecode program for a Java virtual machine.

18. A machine readable medium having stored thereon data that when accessed by a machine causes the machine to perform a method, the method comprising translating a virtual machine program into a threaded code program by translating a virtual machine instruction of the program into an offset value which when logically combined with a base value yields the address of interpretation code to perform the virtual machine instruction.

19. The machine readable medium of claim 18 wherein the value further comprises an offset value which when added to the base value yields the address of the interpretation code.

20. The machine readable medium of claim 18 wherein the value further comprises an offset value which when shifted and added to the base value yields the address of the interpretation code.

21. The machine readable medium of claim 18 wherein the virtual machine instruction is an instruction in a program comprising a translation of a high level source program.

22. The machine readable medium of claim 18 where the virtual machine instruction is an instruction in a bytecode program for a Java virtual machine and the high level source program is a Java program.

23. A machine readable medium having stored thereon data that when accessed by a machine causes the machine to perform a method of executing a program, comprising: adding an element of a threaded code program to a base value to yield an address and executing a code at the address.

24. The machine readable medium of claim 23 wherein the threaded code program comprises a translated virtual machine program.

25. The machine readable medium of claim 24 wherein the virtual machine program is a bytecode program for a Java virtual machine.
